(19) United States
(12) Patent Application Publication
(10) Pub. No.: US 2007/0261686 A1
(43) Pub. Date: Nov. 15, 2007

(54) Process for the Catalytic Partial Oxidation of Liquid Hydrocarbonaceous Fuel

(76) Inventor: Stephan Montel, Amsterdam (NL)

Correspondence Address: SHELL OIL COMPANY, P O BOX 2463, HOUSTON, TX, 772522463, US

(21) Appl. No.: 11/663,117

(22) PCT Filed: Sep. 19, 2005
(86) PCT No.: PCT/EP05/54659

§ 371 Date: Mar. 16, 2007

(30) Foreign Application Priority Data
Sep. 20, 2004 (EP) 04022293.7

(51) Int. Cl. F02B 25/00

(52) U.S. Cl. 123/585

(57) ABSTRACT

The present invention provides a process for the catalytic partial oxidation of a liquid hydrocarbonaceous fuel, comprising the following steps: a) mixing the hydrocarbonaceous fuel with a first amount of molecular oxygen to form a first mixture comprising fuel and molecular oxygen; b) evaporating the fuel by igniting the first mixture; c) mixing the evaporated fuel with a second amount of molecular oxygen to form a second mixture comprising fuel and molecular oxygen; and d) contacting the second mixture with a partial oxidation catalyst for conversion into a product gas comprising at least hydrogen, in which process the overall oxygen-to-carbon ratio is in the range of from 0.3 to 0.8 and the oxygen-to-carbon ratio in the first mixture is in the range of from 0.01 to 0.4.

### FIELD OF THE INVENTION

The present invention provides a process for the catalytic partial oxidation of a liquid hydrocarbonaceous fuel, in particular diesel fuel.

### BACKGROUND OF THE INVENTION

The catalytic partial oxidation of hydrocarbonaceous fuels is a well know in the art and is an exothermic reaction represented by the equation:
CₙH₂ₙ₊₂+n/2O₂→nCO+(n+1)H₂ (1)

There is literature in abundance on the catalysts and the process conditions for the catalytic partial oxidation of hydrocarbons. Reference is made to, for instance, WO 01/046069, U.S. Pat. No. 6,702,960, EP 1341602 and U.S. Pat. No. 6,572,787.

Such processes are for instance employed to produce a fuel gas, typically hydrogen or a hydrogen-rich gas mixture, for fuel cells such as solid oxide fuels cells (SOFC) or proton exchange membrane (PEM) fuel cells.

In addition, on-board operated catalytic partial oxidation of an automotive fuel, such as diesel fuel, is regarded as an option to successfully implement an advanced NOₓ abatement technology for diesel engines. As discussed in Kaspar, J.; Fornasiero, P.; Hickey, N.: “Automotive catalytic converters: current status and some perspectives”, Catalysis Today 77, 2003, 419-449, continuous operation of so-called NOₓ storage/reduction (NSR) or NOₓ adsorber technology requires a proper reducing agent. Experimental investigation has proven that in principal even partly converted mixtures of exhaust gas and fuel can effect a reduction. However, overall system efficiency is expected to be considerably higher when using hydrogen, e.g. generated by means of catalytic partial oxidation.

In order to start and establish catalytic partial oxidation and to achieve the most complete fuel conversion, the fuel must be evaporated and the fuel/oxygen mixture must be preheated before contacting the partial oxidation catalyst. That means that, especially for higher boiling hydrocarbons like diesel fuel, the preferred feed preheat at the inlet to the catalytic zone is up to 400° C. At these conditions, and in particular at hot surfaces like those of heaters, the higher boiling hydrocarbons are prone to form carbonaceous residuals resulting in fouling.

In particular in case of the NOₓ abatement application, the temperature of the main supply of molecular oxygen containing gas can go down to a value of 100° C. during normal engine operation or even ambient temperature during system heat-up right after engine start-up. Realisation of the required feed preheat by means of an electrical heater would require a considerable heater capacity, resulting in higher system weight and volume and increased overall electric energy consumption.

Experimental investigation of so-called cold flames has proven that feed preheat and fuel evaporation can be facilitated without any electrical heater by means of exothermal feed preconversion in the mixer upstream the actual partial oxidation reaction zone, see Hartman, L. et al.: “Design and Test of a Partial Oxidation (POX) Process for Fuel Cell Applications using Liquid Fuels”, Second European Conference on small Burner and Heating Technology (ECSBT 2), Volume II, 411-418, Stuttgart, Mar. 16-17, 2000. However, for initialization of the cold flame the temperature of the oxidising gas, typically air, needs to be increased by electrical preheat up to typically 350° C. Once the cold flame is initialized, which is indicated by a spontaneous mixing temperature rise up to typically 480° C., the air preheat can be reduced.

In US 2003/0233789 is disclosed a fast start-up catalytic reformer. At start-up a lean fuel/air mixture (i.e. near-stoichiometric) is ignited to generate heat in order to preheat the catalyst (combustion mode). When the catalyst is sufficiently preheated, the air to fuel ratio is adjusted to provide a rich fuel/air mixture which is reformed (reforming mode). During operation in the reforming mode the fuel is evaporated by spraying the fuel on the hot outside surface of the reactor in the mixing chamber. Alternatively, the air is preheated by contacting it with the hot outside surface of the reactor in the mixing chamber before being mixed with the fuel. The hot air causes the fuel to evaporate. A disadvantage of the process of US 2003/0233789 is that the dual mode operation requires switching between the combustion and reforming mode.

In US 2004/0144030 is disclosed a method for operating a partial oxidation fuel reformer. In the method of US 2004/0144030, a first air/fuel mixture having a first air-to-fuel ratio is ignited to create a flame. A second air/fuel mixture having a second air-to-fuel ratio is advanced into contact with the flame to generate a reformate gas.

A disadvantage of the process of US 2004/0144030 is that it requires the formation and introduction of two separate air/fuel mixtures into the reformer.

### SUMMARY OF THE INVENTION

It is an object of the present invention to provide an improved process for the catalytic partial oxidation of liquid hydrocarbonaceous fuels. To this end the hydrocarbonaceous fuel is reacted with a first amount of molecular oxygen to generate sufficient heat to evaporate the fuel prior to the catalytic conversion of the fuel.

Accordingly, the invention provides a process for the catalytic partial oxidation of a liquid hydrocarbonaceous fuel, comprising the following steps:
a) mixing the hydrocarbonaceous fuel with a first amount of molecular oxygen to form a first mixture comprising fuel and molecular oxygen;
b) evaporating the fuel by igniting the first mixture;
c) mixing the evaporated fuel with a second amount of molecular oxygen to form a second mixture comprising fuel and molecular oxygen; and
d) contacting the second mixture with a partial oxidation catalyst for conversion into a product gas comprising at least hydrogen,
   in which process the overall oxygen-to-carbon ratio is in the range of from 0.3 to 0.8 and the oxygen-to-carbon ratio in the first mixture is in the range of from 0.01 to 0.4.

An advantage of the process according to the invention is that the fuel is evaporated and preheated to a temperature in a range of from 300 to 500° C. before it contacts the partial oxidation catalyst, whereby the necessary heat is generated with the fuel itself. The no separate, voluminous heater unit is needed, even if the inlet gas has a relatively low temperature, such as 200° C. or even ambient (typically 20° C.). The reaction of the fuel with the first amount of molecular oxygen can be initialized and sustained even at fuel and molecular oxygen supply temperatures as low as ambient temperature, at fluctuating molecular oxygen supply, e.g. when using diesel exhaust gas as molecular oxygen source, and at fluctuating fuel supply.

A further advantages are that a relatively well-defined and energy-efficient operation is facilitated and formation of carbonaceous fuel residuals can be reduced.

A still further advantage is that there is no need to switch between modes of operation.

An even further advantage is all the fuel is introduced with the first mixture. There is no need for several fuel supplies.

### BRIEF DESCRIPTION OF THE DRAWINGS

FIG. 1 schematically shows a fuel processor suitable for the process according to the present invention.

### DETAILED DESCRIPTION OF THE INVENTION

The process according to the present invention is a process for the catalytic partial oxidation of a liquid hydrocarbonaceous fuel. The liquid fuel is mixed with a first amount of molecular oxygen (O₂) to form a first mixture comprising fuel and molecular oxygen (step (a)). Then, the first mixture is ignited, causing the fuel to react exothermically with the molecular oxygen (step (b)). The heat generated by the exothermic reaction causes the fuel in the mixture to evaporate.

The evaporated fuel is mixed with a second amount of molecular oxygen, to form a second mixture comprising fuel and molecular oxygen (step (c)). This second mixture is contacted with a partial oxidation catalyst for conversion into a product gas comprising at least hydrogen (step (d)).

It is preferred that in step (b) only the heat required for the evaporation of the fuel is generated. Therefore, the oxygen-to-carbon ratio in the first mixture is in the range of from 0.01 to 0.4, preferably of from 0.01 to 0.15, more preferably of from 0.02 to 0.10. Reference herein to the oxygen-to-carbon ratio is to the ratio of oxygen molecules mixed with the fuel and carbon atoms in the fuel.

The overall oxygen-to-carbon ratio is in the range of from 0.3 to 0.8, preferably of from 0.40 to 0.75, more preferably of from 0.45 to 0.65. Reference herein to the overall oxygen-to-carbon ratio is to the ratio of oxygen molecules mixed with the fuel in steps (a) and (c) and carbon atoms in the fuel.

It will be clear that the oxygen-to-carbon in the first mixture cannot exceed the overall oxygen-to-carbon ratio. Preferably the oxygen-to-carbon in the first mixture does not exceed 50% of the total oxygen-to-carbon ratio. Therefore, preferably, the first mixture comprises no more than half of the total amount of molecular oxygen mixed with the fuel in steps (a) and (c).

The hydrocarbonaceous fuel is a liquid fuel. Reference herein to a liquid fuel is to a fuel that is liquid at 20° C. and atmospheric pressure. Preferably, the liquid fuel has a final boiling point up to 400° C., more preferably in the range of from 250 to 400° C. Examples of suitable fuels for use in the process according to the invention are gasoline, naphtha, biodiesel, or diesel fuel, preferably diesel fuel. Diesel fuel typically comprises at least 90% (v/v) hydrocarbons with carbon numbers in the range of from C₁₀-C₂₈, preferably C₁₂-C₂₄, more preferably C₁₂-C₁₅.

The molecular oxygen may be comprised in any suitable molecular oxygen-containing gas known in the art. Preferably, the molecular oxygen that is mixed with the fuel in steps (a) and (b) is, independently, comprised in air, diesel exhaust gas or a mixture thereof. Reference herein to diesel exhaust gas is to the exhaust gas generated by an internal combustion engine running on diesel fuel.

The molecular oxygen-containing gas may comprise water. It will be appreciated that depending on the temperature the water will either in a liquid or vapour phase. The overall water-to-carbon ratio is preferably in the range of from above 0.0 to 3.0, more preferably of from above 0.0 to 1.5, even more preferably of from above 0.0 to 1.0. Reference herein to the overall water-to-carbon ratio is to the ratio of water molecules mixed with the fuel and carbon atoms in the fuel. Typically, a molecular oxygen-containing gas like diesel exhaust gas already comprise water.

The process according to the invention is especially suitable for mixing the fuel in step (c) with molecular oxygen that has a temperature up to 400° C. In that case, the heat comprised in the molecular oxygen is not sufficient to evaporate the fuel. It is preferred that the amount of the molecular oxygen mixed with the fuel in step (c) has a temperature in a range of from ambient to 400° C., more preferably in the range of from 200° C. to 400° C.

It is preferred that in step (a) of the process according to the invention, the fuel is mixed with the molecular oxygen in a nozzle to the form of a spray of the first mixture. Such a spray is advantageous as the evaporation of the fuel is accelerated due to the high surface area of the fuel droplets comprised in the spray. A suitable nozzle is for instance an air-assisted nozzle. Preferably, the air-assisted nozzle comprises a fuel rail assembly with a pulse-width-modulated fuel injector and a pulse-width-modulated air injector. It is preferred that the molecular oxygen supply pressure to the nozzle is about 5 or 6 bar and/or that the fuel supply pressure to the nozzle's fuel rail assembly is in a range from 9 to 15 bar.

The first mixture may be ignited in step (b) using any suitable igniter known in the art. Preferably, the first mixture is ignited using a spark plug that is placed in the flow path of the mixture. Suitable spark plugs are typically operated at a voltage in a range from 9 to 13 Volt, which is sufficient to ignite the spray and react part of the fuel with the oxygen.

The partial oxidation catalyst used in step (d) of the process according to the invention may be any catalyst suitable for catalytic partial oxidation. Such catalysts are known in the art and typically comprise one or more metals selected from Group VIII of the Periodic Table of the Elements as catalytically active material on a catalyst carrier.

Suitable catalyst carrier materials are well known in the art and include refractory oxides, such as silica, alumina, titania, zirconia and mixtures thereof, and metals. Preferred refractory oxides are zirconia-based, more preferably comprising at least 70% by weight zirconia, for example selected from known forms of (partially) stabilised zirconia or substantially pure zirconia. Most preferred zirconia-based materials comprise zirconia stabilised or partially-stabilised by one or more oxides of Mg, Ca, Al, Y, La or Ce. Preferred metals are alloys, more preferably alloys containing iron, chromium and aluminium, such as fecralloy-type materials.

Preferably, the catalytically active material comprises one or more Group VIII noble metals, more preferably rhodium, iridium, palladium and/or platinum, even more preferably rhodium and/or iridium. Typically, the catalyst comprises the catalytically active material in a concentration in the range of from 0.02 to 10% by weight, based on the total weight of the catalyst, preferably in the range of from 0.1 to 5% by weight. The catalyst may further comprise a performance-enhancing inorganic metal cation selected from Al, Mg, Zr, Ti, La, Hf, Si, Ba, and Ce which is present in intimate association supported on or with the catalytically active metal, preferably a zirconium cation.

The second mixture is preferably contacted with the catalyst at a gas hourly space velocity in the range of from 20,000 to 10,000,000 Nl/l/h (normal litres of gaseous feed mixture per litre of catalyst per hour), preferably in the range of from 50,000 to 2,000,000 Nl/l/h. Reference herein to normal litres is to litres at Standard Temperature and Pressure conditions, i.e. 0° C. and 1 atm.

The second mixture is preferably contacted with the catalyst at a pressure up to 100 bar (absolute), preferably in the range of from 1 to 50 bar (absolute), more preferably of from 1 to 10 bar (absolute).

The invention is not limited to the above-described embodiments and can be varied in numerous ways within the scope of the claims. For instance, the product gas obtained with the present invention can be fed e.g. to an absorber for hydrogen sulphide or undergo one or more water-gas shift conversions, e.g. low or high temperature water-gas shifts, followed by preferential oxidation for the reduction of carbon monoxide in the fuel gas to yield a product gas that is suitable for fuel cells.

### DETAILED DESCRIPTION OF THE DRAWINGS

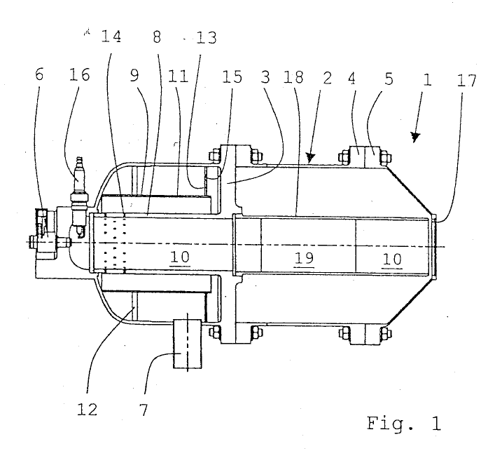

FIG. 1 schematically shows a fuel processor suitable for the process according to the invention. Fuel processor 1 comprises housing 2, consisting of three parts 3, 4, 5, bolted together via respective flanges. The most upstream part 3, which is essentially a mixer, comprises air-assisted fuel nozzle 6 and radially extending inlet 7. Mixer 3 further contains two co-axial cylinders 8, 9, defining main flow path 10 (inside the innermost cylinder) as well as annular duct 11 (between cylinders 8, 9) mounted in mixer 3 by means of bolts 12 and a baffle 13. Openings 14 and 15 are provided in cylinder 8 and baffle 13 respectively. Spark plug 16 is mounted in the wall of mixer 3 and between nozzle 6 and openings 14 in inner cylinder 8. The downstream parts 4, 5 of the housing 2 are provided with outlet opening 17 for the product gas and contain cylinder 18, in line with the above-mentioned inner cylinder 8 thus extending main flow path 10. Cylinder 18 in turn contains catalytic zone 19, for converting the fuel.

In the process according to the invention, diesel fuel and compressed air are fed to nozzle 6 forming a spray comprising the first mixture inside mixer 3.

The first mixture is ignited by spark plug 16. Diesel exhaust gas is fed to inlet 7, and, via the openings 15 in the second baffle 13, through the annular duct 11 (which serves to homogenize the flow profile of the inlet gas) and the openings 14 in the inner cylinder 8, radially into the evaporated fuel. The second mixture is fed to the catalytic zone 19 through cylinder 18. After converting to fuel the product gas is removed from the process through outlet opening 17.

1. A process for the catalytic partial oxidation of a liquid hydrocarbonaceous fuel, comprising the following steps:
a) mixing the hydrocarbonaceous fuel with a first amount of molecular oxygen to form a first mixture comprising fuel and molecular oxygen;
b) evaporating the fuel by igniting the first mixture;
c) mixing the evaporated fuel with a second amount of molecular oxygen to form a second mixture comprising fuel and molecular oxygen; and
d) contacting the second mixture with a partial oxidation catalyst for conversion into a product gas comprising at least hydrogen,
in which process the overall oxygen-to-carbon ratio is in the range of from 0.3 to 0.8 and the oxygen-to-carbon ratio in the first mixture is in the range of from 0.01 to 0.4.

2. A process according to claim 1, wherein the oxygen-to-carbon ratio in the first mixture is in the range of from 0.01 to 0.15.

3. A process according to claim 1, wherein the overall oxygen-to-carbon ratio is in the range of from 0.40 to 0.75.

4. A process according to claim 1, wherein the hydrocarbonaceous fuel has a final boiling point up to 400° C.

5. A process according to claim 1, wherein the hydrocarbonaceous fuel is diesel fuel.

6. A process according to claim 1, wherein in step (a) the fuel is mixed with oxygen in a nozzle to form a spray of the first mixture.

7. A process according to claim 1, wherein the oxygen mixed with the fuel in steps (a) and (c) is selected from the group consisting of air, diesel exhaust gas and mixtures thereof.

8. A process according to claim 1, wherein the oxygen mixed with the fuel in step (c) has a temperature in the range of from ambient to 400° C.

9. A process according to claim 1, wherein the first mixture is ignited using a spark plug.

10. A process according to claim 1, wherein the overall oxygen-to-carbon ratio is in the range of from 0.45 to 0.65.

11. A process according to claim 1, wherein the oxygen-to-carbon ratio in the first mixture is in the range of from 0.02 to 0.10.

12. A process according to claim 1, wherein the oxygen-to-carbon ratio in the first mixture is in the range of from 0.02 to 0.10 and the overall oxygen-to-carbon ratio is in the range of from 0.45 to 0.65.

13. A process according to claim 1, wherein the oxygen mixed with the fuel in steps (a) and (c) comprises air.

14. A process according to claim 1, wherein the oxygen mixed with the fuel in steps (a) and (c) comprises diesel exhaust gas.
